(19) United States
(12) Patent Application Publication
(10) Pub. No.: US 2005/0229099 A1
(43) Pub. Date: Oct. 13, 2005

(54) Presentation-independent semantic authoring of content

(76) Inventors: Dale E. Rogerson, Seattle, WA (US); J. Shane McRoberts, Seattle, WA (US); Andrew D. Reddish, Seattle, WA (US); Kipper York, Seattle, WA (US); Ginger Gloystein, Lincoln, NE (US); Sridhar Chandrashekar, Redmond, WA (US)

Correspondence Address: WOODCOCK WASHBURN LLP, ONE LIBERTY PLACE - 46TH FLOOR, PHILADELPHIA, PA, 19103, US

(21) Appl. No.: 10/819,661

(22) Filed: Apr. 7, 2004

(51) Int. Cl. G06F 17/00

(52) U.S. Cl. 715/523

(57) ABSTRACT

A content author marks content semantically, rather than providing presentational indications in the content. The markings conform to a semantic schema, which define different semantic elements which may occur in the content. The resulting semantically-marked content is optionally combined with other semantically-marked content to form combined semantically-marked content. The final presentationally-marked content is transformed with a presentation transform indicating how semantic content should be displayed. The result is presentation data. The presentation data contains the content with presentational indications, including presentational markings or code references or fragments. These presentational indications indicate how content should be displayed. In this way, uniformity in presenting data authored by different content authors or at different times can be achieved.

### CROSS-REFERENCE TO RELATED APPLICATIONS

The subject matter described herein is related to the subject matter disclosed in application Ser. No. 10/754,984 (attorney docket no. 304117.01/MSFT-2861) filed on Jan. 9, 2004 entitled “System and Method for Context Sensitive Searching.” The subject matter described herein is also related to U.S. patent application Ser. No. YY/YYY,YYY (attorney docket no. MSFT-2907/305488.01), entitled “Activating Content Based on State” and U.S. patent application No. ZZ/ZZZ,ZZZ (attorney docket no. MSFT-2910/306008.01) entitled “In-Place Content Substitution via Code-Invoking Link,” both filed on the same date as the present application.

### FIELD OF THE INVENTION

This invention relates in general to the field of information technology. More particularly, this invention relates to a computing environment context to facilitate presentation-independent authoring of content, and to the display of such content.

### BACKGROUND OF THE INVENTION

When information is presented to a viewer, the work of presenting the information can be divided into two areas. The first is authoring the content which will be presented to the user. For example, when an author writes a book, the act of choosing the words to use constitutes the authoring of the content.

Choosing the way in which the content will be displayed constitutes the second part of the presentation of information. When the book is to be published, however, the words that the author has been chosen are presented in a certain typeface, a certain size, with certain line lengths and spaces between lines. These are presentation decisions.

Similarly, in a computing environment, in presenting information for display to a user, the content must be authored, and the presentation details must be decided upon.

In both the general context and in the computing environment context, the author of content may wish to specify certain details of how the content will be displayed. For example, a poet may wish to include non-standard spacing in a poem. The author of a book may wish to present a list, and have the elements of the list to each begin with a bullet or a hyphen in order to facilitate a reader's understanding of the list. In the computing environment context, a content author may also wish to have content displayed in a way which will enhance the user's understanding of the content.

For example, one important context within the computing environment context in which information is presented to a user is the help context. In the help context, help information on a topic is presented, for example for operating systems and applications such as spreadsheets, word processing, and business applications. In such a context, the content author may want to have the help content displayed in a way which allows a user to better understand it. For example, in help content where a user is instructed to input certain text, that certain text which a user is instructed to type may be presented in a different font than the rest of the text of the help content. A numbered or bullet list may be used to order information and make it more comprehensible to a user. Boldface, underlining, different colors, or other text effects may also be used.

In prior art help systems both the content to be displayed and the presentation information must be contained in the help content. Some examples of such systems are Microsoft Corporation's WinHelp system and HTML Help 1.x systems, which are or were used in certain versions of Microsoft Corporation's WINDOWS operating system. In such systems, the authoring of help content required both content authoring and a content presentation. The help content, according to such systems, is written in a format which allows both content and presentation information to both be specified. For example, in Microsoft Corporation's rich text format (RTF), used for content in the WinHelp system, the author of help content would need to author both the content and specify how it should be presented, e.g. with certain words boldfaced or underlined. Similarly, using the hyper text markup language (HTML) protocol, as the HTML Help 1 .x system did, the author of help content would need to include tags within the HTML document. These tags would specify that some piece of content should be boldface, or is an item in a bullet or numbered list.

The prior art help systems are limited, because they force a content author to also be a presentation author, even where different people may be better suited to perform these different tasks. Additionally, where different people are authoring help content, it may be difficult to maintain uniformity in the presentation style of help content. Another limitation is the necessity of authoring help content in a specific format language. It may be desirable to use one format (e.g., HTML) with help content, however, where the help content may be used in systems without the capability of displaying content in that first format, it may be necessary to use a second format (e.g., RTF) to display help content if that format is more widely available. Other types of variations in presentation based on the capabilities of the user's system may also be desired.

Additionally, a change in one an aspect of presentation after the help content is authored is difficult to perform in prior art systems which display content. As an example, after the authoring of help content is completed, a change may be required in how example text to be input by users is displayed. In the already authored help content, for example, text to be input by users was underlined by the authors of help content. Then the discovery may be made that users comprehension is increased when text to be input is displayed in a different font than the rest of the code. In order to make the change, a global search and replace may be instituted to replace all underlining commands to commands which change the font of the text. However, this will be over-inclusive, changing every instance of underlining, not just those which are used to emphasize what example text to be input by a user. An alternative way to make the change would involve examining each instance of underlining and determining whether or not it should be changed. This is obviously a time-intensive process and may introduce errors in the presentation style.

Thus, there is a need for a system and method to overcome these deficits in the prior art. The present invention addresses the aforementioned needs and solves them with additional advantages as expressed herein.

### SUMMARY OF THE INVENTION

Semantic marking is used by a content author. These semantic markings are used with respect to certain elements of content. For example, some content may be marked as “help topic heading”. These semantic markings, alone or in combination, are used to determine what the presentation of the marked content will be.

In one embodiment, the presentational content (content ready for display using an interpreter of a presentational format such as hypertext markup language (HTML)) is produced by accepting semantically-marked content and applying a presentational transform. A presentational transform then transforms the semantically-marked content into a presentational format.

Semantically-marked content fragments may be combined with other semantically-marked content fragments through one or more structural transforms. The resulting combined data (a structurally-transformed content topic) is then transformed using the presentational transform.

Other features of the invention are described below.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing environment in which aspects of the invention may be implemented;

FIG. 2 is a block diagram of the transformation of semantically-marked content to presentational content according to one embodiment of the invention;

FIG. 3 is a flow diagram of a method for producing presentational content for display according to one embodiment of the invention;

FIG. 4 is a flow diagram of a method for producing content for display according to one embodiment of the invention; and

FIG. 5 is a block diagram of the content transformation engine on a user's computer system according to one embodiment of the invention.

### DETAILED DESCRIPTION OF ILLUSTRATIVE EMBODIMENTS

Overview

According to one embodiment of the invention, an improved authoring scheme for content which is to be displayed to a user is provided. A help system will be used in this specification to describe the invention, however, the invention is not limited to use in help systems, but rather can be more widely used, for example, in other systems where content is authored to be displayed on a variety of systems or where presentation style is required to be changeable. For example, reference documentation for a software application constitute all or part of the content according to one embodiment of the invention. Tutorial materials for a software application constitute all or part of the content according to another embodiment of the invention.

Exemplary Computing Environment

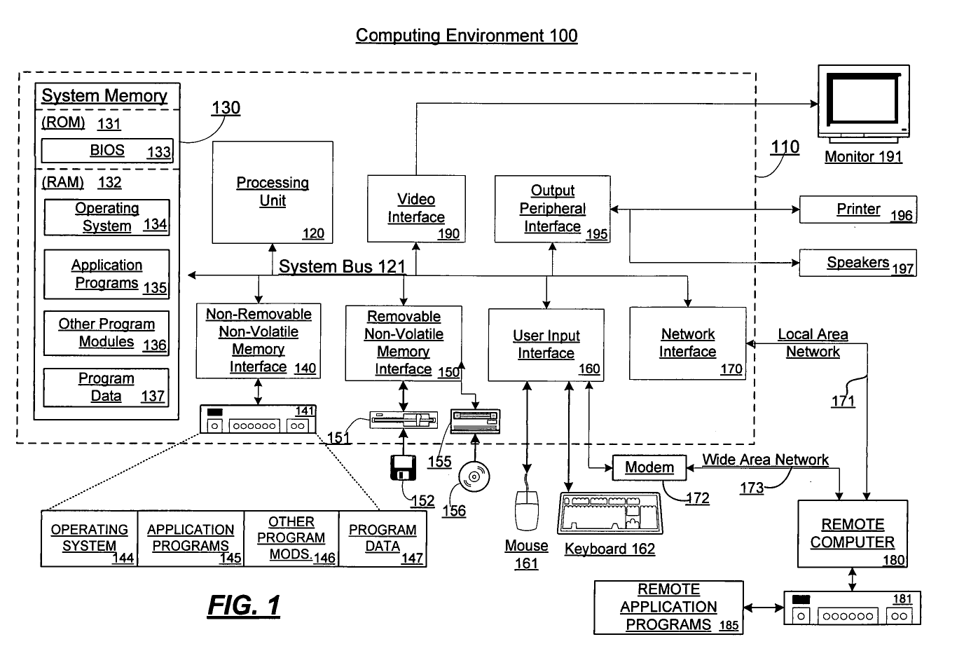

FIG. 1 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Authoring Semantically-Marked Content

The help system content is authored by a content author. Instead of describing how the content should be displayed in purely presentation terms, the content author authors the content and describes the content in functional (semantic) terms. Thus authors do not need to know how to code in a language which will specify how content should be presented. Rather, an author codes certain items of content semantically. For example, content which is example text to be entered by a user would be marked as example text, rather than as content which is to be displayed in a certain way (in a given font, or underlined.)

A schema is established with which the author of content can specify semantically certain items of content. In one embodiment, an extensible markup language (XML) schema is used to author the content. The XML schema describes the purpose of certain items of the content. The schema is not limited to establishing the semantic purpose for a word or phrase in the content. The schema can be used to specify a semantic description for all of the content, or for a specific word or a character of one word.

The following pseudocode is an example of how content may be described in semantic terms:
<title> Turn on or off automatic spelling and grammar checking <title>
<procedure>
<step>On the <menu_name>Tools </menu_name> menu, click <menu_item>Options </menu_item>, and then click the <tab>Spelling and Grammar</tab> tab.</step>
<step>Do one or both of the following:

<option>To turn on or off automatic spelling checking, select or clear the <checkbox_name>Check spelling as you type </checkbox_name> check box. </option>
<option> To turn on or off automatic grammar checking, select or clear the <checkbox_name>Check grammar as you type </checkbox_name> check box. </option></step>
</procedure>

Thus, in the example pseudocode above, the content “Turn on or off automatic spelling and grammar checking” is indicated to be, semantically, a help topic heading. Similarly, two steps are indicated for the user to perform. The latter of the steps provides two possible options to be performed by the user. The content “Check grammar as you type” is indicated as being a checkbox name, however it is also part of the second option given in the second step. In the above pseudocode semantic function for a specific element is illustrated by including it between tags (e.g. the <help topic heading> and </help topic heading> tags for the help topic heading surround “Turn on or off automatic spelling and grammar checking,” which is to be considered, semantically, a help topic heading).

The indication of a semantic function for a content element, however, this can be done in a number of ways. Indicating semantic function for an element of content can be done by the content author directly by writing content with such markups or other indications of semantic function for the element as required in the selected schema. Alternatively, this can be done by using an environment which simplifies the process of marking content elements with semantic function for a content author, such as an environment which allows a user to highlight elements of content and indicate their semantic function by selecting a semantic function from a list of possibilities.

The author of the content does not need to determine how such an element with a given semantic function will be displayed, but only to author the content and to mark any content elements with semantic descriptions.

Display of Semantically-Marked Content

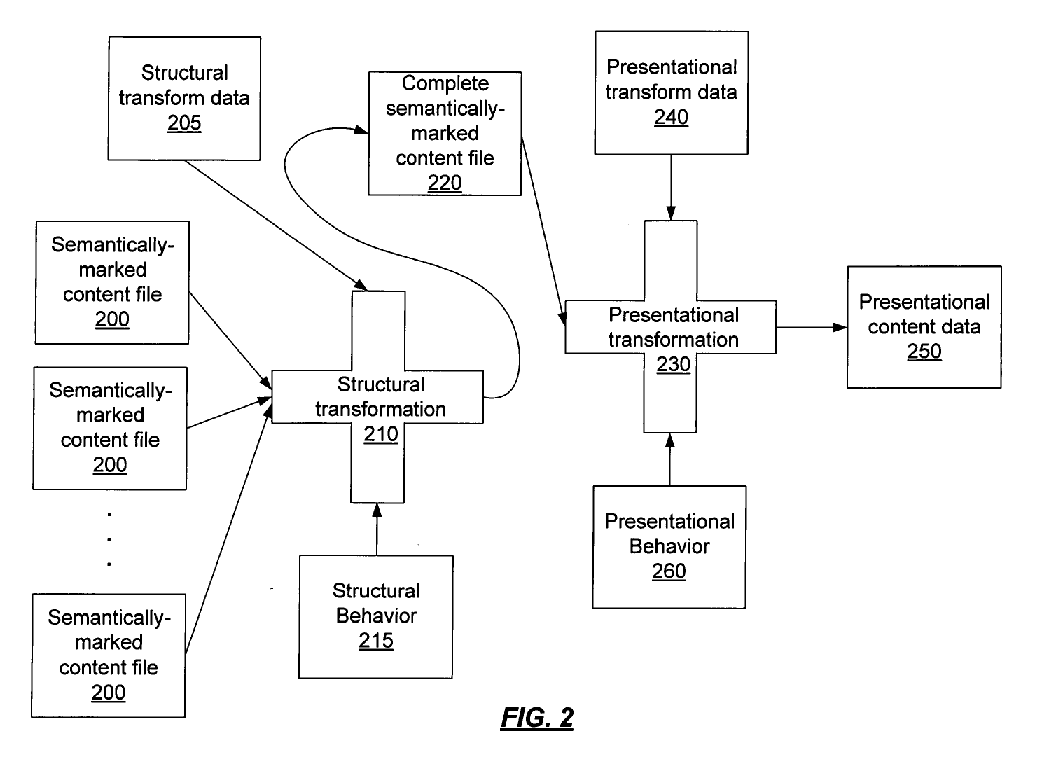

Once the semantic authoring of the content has been completed, it must be transformed in order to be displayed. FIG. 2 illustrates the transformation of semantically-marked content to presentational content. First, structural transformations, if any, may be performed. Semantically-marked content files 200 include the content to be displayed and semantic markings of some of the content. One or more semantically-marked content files 200 may be combined in order to provide content for a display to the user. For example, in the context of a help system, it may be helpful to have a fragment of a help topic displayed along with one other fragment in one help topic, and with other fragments in a different help topic. For example, a common area where a number of settings may be displayed and changed (a control panel) may be available to the user. If a number of help topics will direct a user to such a control panel, for example, only one content fragment is needed to describe the access for that control panel, and then other fragments can describe different actions to take once the control panel is accessed.

In order to execute such a combination of fragments of content for a single display, as shown in FIG. 2, the semantically-marked content file 200 for each of the help fragments is an input to a structural transformation 210. Any number of structural transformations 210 may be performed (including none). The result of any structural transformations is a complete semantically-marked content file 220. Structural transform 210 may structural transform data 205. Structural transform data 205 describes how the semantic elements should be combined.

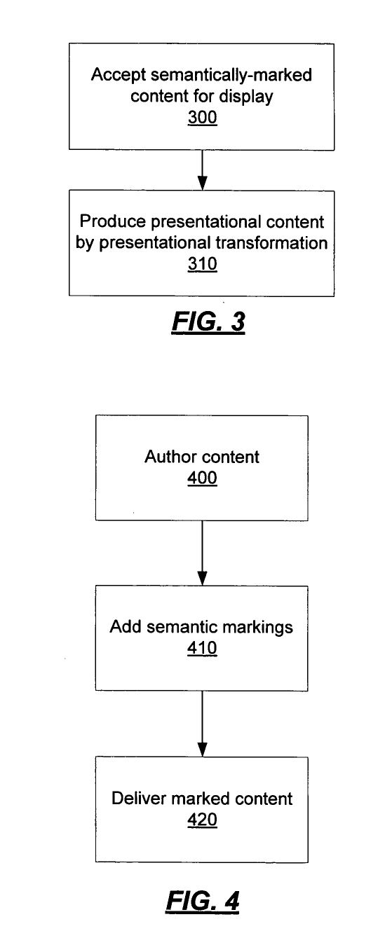

FIG. 3 is a flow diagram of a method for producing presentational content for display according to one embodiment of the invention. As shown in FIG. 3, such a method begins with the acceptance of semantically-marked content for display, step 300. Presentational content is produced by a presentational transformation of the semantically-marked content in step 310. Additionally, though not shown in FIG. 3, one or more structural transformations may occur before the presentational transformation of step 310. Step 310, in which presentational content is produced by a presentational transformation of the semantically-marked content, may be performed dynamically, upon a user's request. Transformed content, however, may also be cached, and the presentational transformation may instead be an access of already-transformed content. For example, in one embodiment, content has already been presentationally transformed for display, and such transformed content is accessed and presented instead of performing the transformation again. In another embodiment, one or more content topics is presentationally transformed and stored, in order to expedite the delivery of presentationally transformed data upon a user's request.

FIG. 4 is a flow diagram of a method for producing content for display according to one embodiment of the invention. As shown in FIG. 4, step 400, content is authored. In step 410, semantic marking(s) are added to the content. In step 420, the content is delivered.

With reference again to FIG. 2, the complete semantically-marked content file 220 is a content file which contains all the content to be displayed, along with semantic indications for selected elements of the content file. (If no structural transformations 210 have been performed, the complete semantically-marked content file 220 is the original semantically-marked content file 200 to be displayed.) In order to transform the combined content file 220 a presentational transform 230 is performed. A further input to the presentational transform, is presentational transform data 240. The presentational transform data 240 describes how the semantic elements should be rendered. The presentational transform data 240, in one embodiment, includes extensible stylesheet language transforms (XSLT).

For the elements of content which are indicated to have a certain semantic meaning in the content, the presentational transform data 240 describes how such elements should be presented. For example, Table 1 is an example of what may be included in the presentational transform data 240.

TABLE 1
First Presentational Transform Data example

| Semantic element | Treatment |
|---|---|
| title | Initial capitals, Underline |
| step | Numbered list item |
| menu_name | Boldface |
| option | Bullet list |
| menu_item | Italicized |
| tab_option | Double underline |
| checkbox_name | Precede with checkbox graphic, Boldface |

The resulting presentational content file 250 contains the content as it will be presented. This may be in any of a number of formats. For example, it may be in HTML or RTF format. When the content described by the pseudocode above is transformed according to the presentational transform data 240 as represented in Table 1, the following table provides an example of the resulting content:

TABLE 2
Content as presented according to presentational transform data in Table 1
Turn On Or Off Automatic Spelling And Grammar Checking

| | |
|---|---|
| 1. | On the Tools menu, click Options and then click the |
| | Spelling & Grammar tab. |
| 2. | Do one or both of the following: |
| | To turn on or off automatic spelling checking, select or clear |
| | the [symbol] Check spelling as you type check box. |
| | To turn off automatic grammar checking, select or clear the [symbol] |
| | Check grammar as you type check box. |

However, a different presentational transform data 240 yields a different presentation of content, as can be seen in Table 3, a second example of what may be included in the presentational transform data 240.

TABLE 3
Second Presentational Transform Data example

| Semantic element | Treatment |
|---|---|
| Title | All capitals |
| Step | Preceded by dash |
| menu_name | Boldface, all capitals |
| Option | Bullet list |
| menu_item | Italicized |
| tab_option | Underline |
| checkbox_name | Precede with checkbox graphic, all capitals |

When the content described by the pseudocode above is transformed according to the presentational transform data 240 as represented in Table 3, Table 4 provides an example of the resulting content:

TABLE 4
Content as presented according to presentational transform data in Table 3
TURN ON OR OFF AUTOMATIC SPELLING AND
GRAMMAR CHECKING

```
On the TOOLS menu, click OPTIONS and then click the Spelling &
Grammar tab.
Do one or both of the following:
  To turn on or off automatic spelling checking, select or clear
  the [symbol] CHECK SPELLING AS YOU TYPE check box.
  To turn off automatic grammar checking, select or clear
  the [symbol] CHECK GRAMMAR AS YOU TYPE check box.
```

Both the presentational transform data in Table 1 and Table 3 may be included in presentational transform data 240. For example, where content is transformed differently based on state (as described below), the presentational transform data in Table 1 may be used for one state, and the presentational transform data in Table 3 may be used for another state.

In one embodiment, the structural transformations (if any) and the presentational transformation occur on the user's computer system. In this way, the presentational transform data 240 may be customized for the available presentational language available for the user. For example, if a user's computer includes only RTF format display capabilities, but not HTML format display capabilities, the presentational transform data may be specific to transforming semantically-marked content to presentational content in RTF format. A server system could, for example, presentationally transform the semantically-marked content into one format for access by external systems via a web browser while retaining (without presentational transformations) the semantically-marked content for later presentational transformation by a user of the help system local to the server itself.

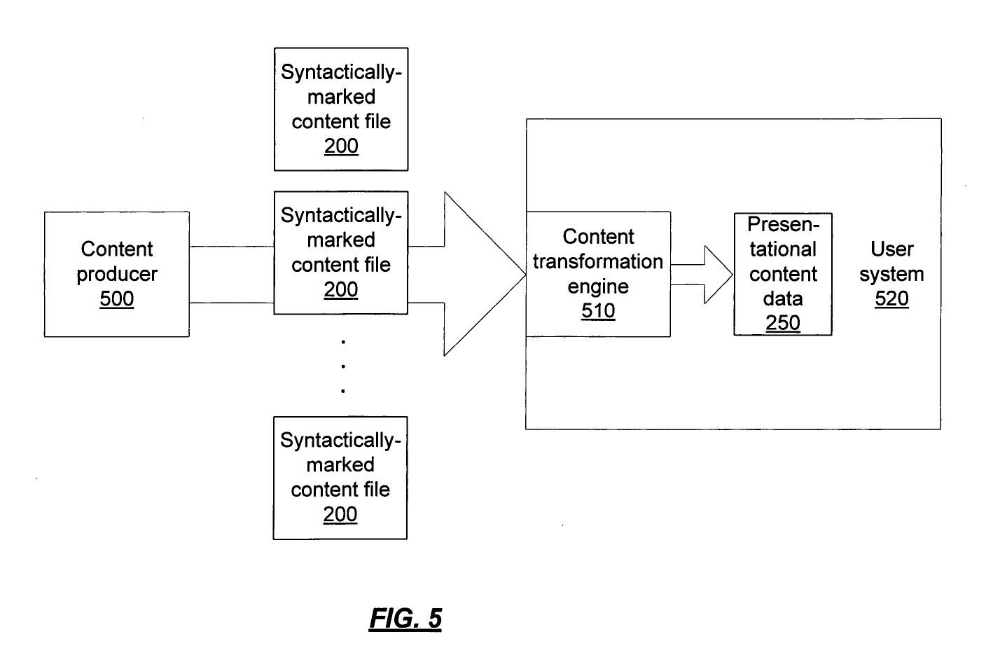

FIG. 5 shows one example of the content transformation engine on a user's computer system. A content producer 500 provides one or more semantically-marked content files 200. These files may come from one content producer, or from a number of content producers. A content transformation engine 510 in user system 520 transforms these into presentational content data 250. In one embodiment, the transformation occurs when the semantically-marked content files 200 are needed in the help system. In another embodiment, the transformations are done at the build time for the help system.

It can be seen in the examples in Tables 1-4 above that not only are text effects added to the content, but occasionally the content is modified in response to the presentational transformation. For example, the help topic heading in Table 2 has been transformed from only one capital letter to be displayed with initial capital letters on each word. Such text changes may be more far-reaching. For example, where an example name is given (for example, in help discussing how to address a letter) if semantically marked, the example name may be modified based on the regional settings of a user's computer or the version of the presentational transform data 240 of the user.

Additional effects may include effects such as presentational behaviors. One such presentational behavior is a popup which appears when a user hovers a cursor over a word. In this way, for example, glossary definitions may be provided. If the semantically-marked content includes the following, as exemplified in pseudocode:
In order to provide help for a writer, this program provides the <term>Thesaurus <definition>Replaces a word or phrase in the document with a synonym, antonym, or related word.</term></definition>.

This pseudocode indicates that the content includes a term (“Thesaurus”) and what the definition is of that term. Thus, with reference again to FIG. 2, depending on the presentational transform data 240, when the presentational content file 250 is displayed, the definition may be disregarded (not displayed), or alternately may be displayed when a user clicks on the term, or, as still another alternative, the definition may be displayed in a pop-up box when the user hovers the cursor over the term. In one embodiment, based on a policy or security setting, some content is not included in the presentational content file 250, or included only in such a way as to be invisible when the presentational content file 250 is rendered (but viewable in the source.

The availability of such more-complex behaviors via the presentational transform 230 serves to point out the security benefits of using the inventive methods and systems. Because the semantically-marked content does not include the scripting or other programmatic instructions on how the presentation will be accomplished, it is acceptable to allow content providers to provide semantically-marked content without verifying their trustworthiness, as long as the presentational transformation 230 occurs under a higher level of security and using presentational transform data 240. In addition to this gain in security, providing the presentation enhancements by means of the presentational transform 230 also removes the burden of coding any such presentation enhancements from providers of content.

As can be seen from FIG. 2, in one embodiment, structural behavior 215 is an input to structural transform 210 and presentational behavior 260 is an input to presentational transform 230. This is another way in which the presentational content may be adapted to the viewing user's computer. Behavior data is data which defines different behaviors that may occur at run time.

One type of behavior data is code. In one embodiment, in order to allow content to be adapted, the content contains at least one link to code (known as a “behavior”) which can be executed to modify or add content. At a transformation time, the code invoked by the link is accessed and run, which may change the content. The use of such behaviors is detailed in co-pending, co-assigned U.S. patent application Ser. No. ZZ/ZZZ,ZZZ (attorney docket no. MSFT-2910/306008.01), filed on the same date as the present application.

One type of behavior data is based on state information regarding the user, user's computer, or application. The state information may be provided by one or more monitors which monitor a system to provide context information. Each monitor tracks information about a particular state including whether it is currently true or false. Examples of states which may be useful in determining the context of a search include hardware, software, and user preferences and controls. Hardware states may include the type, model, make, and status of hardware attached to the user computing device. Internet connection state, the local network and the presence of a shared printer, multiple displays, and the type of network are also examples of states in a computing environment. Examples of software states may be the version of operating system used or the application being run and the mode of the application such as editing a document or creating an equation for calculation in a spreadsheet. Examples of user related states include user preferences and conditions such as whether the user is a system administrator, whether the user has selected specific styles or modes in the generation or viewing of documents. Additional states representative of the computing environment may be monitored as new content is downloaded or new applications are installed. The gathering of such state information is detailed in co-pending, co-assigned U.S. patent application Ser. No. 10/754,984 (attorney docket no. 304117.01/MSFT-2861). The use of such state information is detailed in co-pending, co-assigned U.S. patent application Ser. No. YY/YYY,YYY (attorney docket no. MSFT-2901/305488.01), filed on the same date as the present application.

Conclusion

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

1. A method for producing presentational content for display comprising:
accepting semantically-marked content comprising content to be displayed and at least one semantic marking of some portion of said content; and
producing presentational content by a presentational transformation of said semantically-marked content defining how said at least one semantic marking should be displayed.

2. The method of claim 1, further comprising:
combining said semantically-marked content with additional semantically-marked content by at least one structural transform defining how said combination should occur.

3. The method of claim 1 where said presentational transformation occurs according to presentational transform data.

4. The method of claim 3, where said semantically-marked content is in an XML format, and where said presentational transform data is in an XSLT format.

5. The method of claim 1, where behavior information is used in said presentational transform.

6. The method of claim 1, where said presentational content is in a specific presentational format capable of being displayed in a specific computing environment, and where said step of producing presentational content occurs at least in part in said computing environment, said method further comprising:
displaying said presentational content in said computing environment.

7. The method of claim 1, where said step of producing presentational content occurs after a request for content has been made by a user.

8. The method of claim 1, where said presentational content comprises one or more selected from among the following group: help content for a software application, documentation for a software application, and tutorial materials for a software application.

9. The method of claim 1, where said step of producing presentational content comprises removing some portion of said semantically-marked content.

10. The method of claim 1, where said step of producing presentational content comprises setting some portion of said semantically-marked content to not be displayed.

11. The method of claim 10, where said setting some portion of said semantically-marked content to not be displayed comprises allowing a user to see said portion of semantically-marked content only on request.

12. At least one of an operating system, a computer readable medium having stored thereon a plurality of computer-executable instructions, a co-processing device, a computing device, and a modulated data signal carrying computer executable instructions for performing the method of claim 1.

13. A method for producing presentational content for display comprising:
authoring content to be displayed;
adding at least one semantic marking of some portion of said content according to a semantic schema; and
delivering said content for the production of presentational content by a presentational transformation defining how content marked according to said semantic schema should be displayed.

14. At least one of an operating system, a computer readable medium having stored thereon a plurality of computer-executable instructions, a co-processing device, a computing device, and a modulated data signal carrying computer executable instructions for performing the method of claim 13.

15. A system for producing presentational content for display comprising:
content storage for storing semantically-marked content comprising content to be displayed and at least one semantic marking of some portion of said content; and
a presentational transformer for producing presentational content by a presentational transformation of said semantically-marked content defining how said at least one semantic marking should be displayed.

16. The system of claim 15, further comprising:
a structural transformer for combining said semantically-marked content with additional semantically-marked content by at least one structural transform defining how said combination should occur.

17. The system of claim 15 where said presentational transformation occurs according to presentational transform data.

18. The system of claim 17, where said semantically-marked content is in an XML format, and where said presentational transform data is in an XSLT format.

19. The system of claim 15, where state information is used in said presentational transform.

20. The system of claim 15, where said presentational content is in a specific presentational format capable of being displayed in a specific computing environment, and where said step of producing presentational content occurs at least in part in said computing environment, said system further comprising:
a display for displaying said presentational content in said computing environment.

21. The system of claim 15, where presentational content is produced by said presentational transformer after a request for content has been made by a user.

22. The system of claim 15, where said presentational content comprises one or more selected from among the following group: help content for a software application, documentation for a software application, and tutorial materials for a software application.

23. A system for producing presentational content for display comprising:
content accepting means for accepting semantically-marked content comprising content to be displayed and at least one semantic marking of some portion of said content; and
presentational transformation means producing presentational content by a presentational transformation of said semantically-marked defining how said at least one semantic marking should be displayed.

24. A system for producing presentational content for display comprising:
content authoring means for authoring content to be displayed;
semantic marking addition means for adding at least one semantic marking of some portion of said content according to a semantic schema; and
content delivery means for delivering said content for the production of presentational content by a presentational transformation defining how content marked according to said semantic schema should be displayed.
